(19) United States
(12) Patent Application Publication
(10) Pub. No.: US 2018/0288577 A1
(43) Pub. Date: Oct. 4, 2018

(54) Personal Item Embedded Security System and Method

(71) Applicant: Elisa J. Will, Austin, TX (US)

(72) Inventor: Elisa J. Will, Austin, TX (US)

(21) Appl. No.: 15/476,553

(22) Filed: Mar. 31, 2017

(51) Int. Cl. H04W 4/12

(52) U.S. Cl. CPC H04W 4/12; H04W 4/22

(57) ABSTRACT

A system and method are provided in which a personal security system is embedded in or disguised by a personal item. The personal security system comprises a transmitter and receiver or transceiver through which location-related data from a GPS or other location determining system is acquired. Location information, as well as a code that identifies characteristics associated with the user, is then conveyed to a receiving system. Consequently, a user about whom descriptive data is associated with the code can secretly employ an embodiment to send a signal that can be received by authorities and interpreted as a security event, such as a kidnapping or assault as it is underway. The location information from the apparatus can be re-sent by the user as the kidnapping or assault is proceeding to provide a travel vector to allow authorities or others to determine a probable direction and time of travel thus increasing the likelihood of intervention.

### FIELD OF THE INVENTION

The present invention relates to personal security systems and, in particular, to systems and methods configured to alert authorities or designated others that the personal safety or well-being of a designated user is at risk.

### BACKGROUND

It is believed by some investigators that approximately 70,000 people are victims of non-parental kidnapping each year in the United States. There are thought to be at least 10,000 murders a year in the United States. Other countries suffer even greater numbers of kidnappings and murders. For example, in 2012 in Mexico, over 100,000 kidnappings were reported. No matter what the exact numbers may be, crimes such as kidnapping and murder are, to the victim, the relatives, and the community at large, some of the most horrible and, if survived, debilitating psychological experiences a human being can suffer in the modern world.

As is well known, kidnapping can easily lead to death or bodily harm to the victim. Crime investigators often say that productive action in the first few hours after a kidnapping is crucial in foiling a kidnapping. However, it is often difficult for investigators to be aware of when those important hours begin or in what direction the perpetrator has fled with the victim. A kidnapping victim is, by definition, taken from a known place to another location which is, at least at the commencement of the event, indeterminate. Thus the location is masked and, the time of occurrence can be indeterminate as well leading to increased danger to the victim. Consequently, crucial time can pass as the perpetrator steals the victim away in an unknown direction before the authorities can be altered or family assistance initiated. In some cases, the perpetrator and victim can be across state lines before investigators are altered to the possibility of kidnapping. Further, investigators will frequently not have a useful description of the victim until well after the event begins, much less the direction of travel and time of the incident

Prior personal security systems have typically been stand-alone systems typified by an electronic device distinct from the clothing or personal items of the person whose safety is purportedly enhanced by access to the device. Consequently, a would-be kidnapper or assailant would be likely to recognize the risk to his scheme presented by an obvious electronic monitoring device carried by the victim and would, therefore, be likely to discard such a device that can so readily be discovered. What is needed, therefore, is a system that can avoid detection while still allowing an identifiable victim to surreptitiously alert authorities through an established monitoring system that her personal safety is at risk.

### SUMMARY

A system and method are provided in which a personal security system is embedded or disguised in a personal item. The personal security system comprises a transmitter and receiver or transceiver through which location-related data from a GPS or other location determining system is acquired. Location information, as well as a code that may identify the user, is then conveyed to a receiving system. Consequently, a user associated with the code can surreptitiously employ an embodiment to send a signal that can be received by authorities and be interpreted as a security event, such as a kidnapping or assault, which is underway. The location information from the apparatus can be re-sent by the user as the event is proceeding to provide a travel vector to allow authorities or others to determine salient fact such as, for example, a probable direction or time of travel thus increasing the likelihood of intervention and rescue.

In a preferred embodiment, the system is embedded in a personal item such as an item of clothing or a fashion accessory and is consequently camouflaged from open view and less likely to be noticed and therefore separated from the registered user by a culprit. Embodiments can be incorporated with features to allow use of an embodiment with a variety of shoes, clothes, belts, purses, backpacks, jewelry, or other personal items.

In those communities with text capable 911 systems, the distress signal from the system may be a text message to 911 that includes location information such as location coordinates and the code associated with the registered user. In other environments, the distress signal from the system may be conveyed on a frequency that is locally monitored by authorities. In even other embodiments, the distress signal may be embodied as a location information text message to a phone number of, for example, a family member or friend. When coordinates are received as a text message, the recipient will be aware that the registered user is facing a personal risk and will be able to respond accordingly.

For example, from reception by a text capable 911 system, authorities can be altered that a distress signal from the personal security system of a registered user has been received and intervention by the authorities can be initiated.

### BRIEF DESCRIPTION OF THE FIGURES

FIG. 1A depicts an embodiment of the present invention.

FIG. 1B depicts a data compilation employed to associate a preferred system with a particular user.

FIG. 2 depicts a view of the back of the buckle of a belt to show a transceiver in accordance with an embodiment of the invention integrated into the buckle.

FIG. 3 is a functional depiction of receiving and transmitting modules employed in a preferred embodiment of the present invention.

FIG. 4 depicts an alternative functional configuration of functional modules that may be employed in some embodiments of the invention.

FIG. 5 depicts an embodiment in which the personal accessory is a bracelet.

FIGS. 6A and 6B depict exemplar triggers for initiating a distress signal from embodiments of the personal accessory employed in an exemplar system of the invention.

### DETAILED DESCRIPTION OF VARIOUS EMBODIMENTS

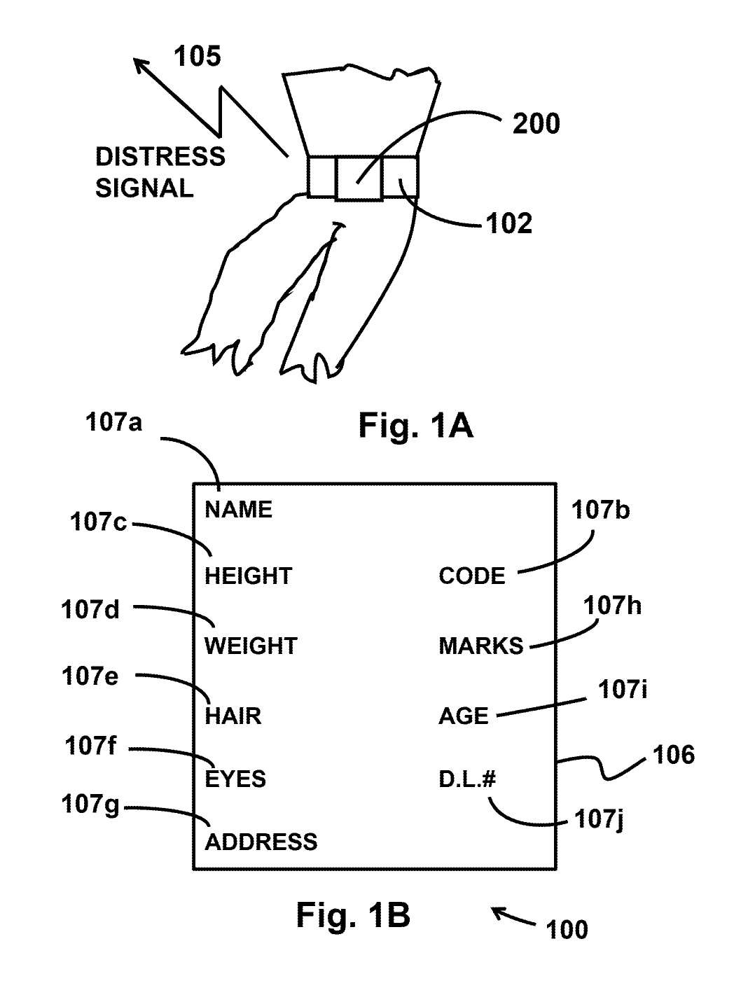

An embodiment of a system 100 in accordance with the present invention is depicted in FIGS. 1A and 1B. System 100 employs a receiver and transmitter or transceiver 200 incorporated into a personal item or accessory 102 of a registered user. In the depicted embodiment, personal item 102 is a belt but, as those of skill will recognize once this disclosure is appreciated, any of a variety of fashion, clothing or personal accessories may be employed to advantage with a variety of embodiments. A non-limiting exemplar list of useable personal items 102 includes belts, shoes, backpacks, hairpieces or clips, necklaces, bracelets, and clothing. In clothing, for example, receiver/transmitter or transceiver 200 may be hidden along seams and cuffs or attached to or made integral with buckles or fasteners. Module 200 with which the personal item is deployed may be integrated in a non-obvious location and the person item only need be of a size sufficient to conceal or camouflage the transceiver or transmitter/receiver. Those of skill will understand that transceiver 200 may be implemented as a separate transmitter and receiver or, as a more tightly integrated functional unit more commonly identified as a transceiver. However, when the term transceiver is employed in this disclosure it should be understood to encompass both a transceiver as a physically combined unit including both a receiver and a transmitter or it may refer to the combination of a receiver and a transmitter implemented as separate circuits or even separate modules or as separate physical devices.

A user who employs a preferred embodiment of the invention is preferably associated with the particular embodiment by a process that will be called “registration” which is the association of one or more particular characteristic of or linked with or descriptive of the user with the device through a code unique to the particular embodiment—user combination. Typically, registration is effectuated by the provision of a set of identifying datum to the system compilation depicted by reference 106 of FIG. 1B that identifies the user associated with the particular personal item 102 that includes the transceiver embodiment. The system compilation 106 may be a flat or relation database or any other of the many well-known configurations of data storage and may even be as minimal as a single number such as, for example, a driver's license number or an address or other identifying datum associated with the user. Compilation 106 may also be a list of data that identifies the registered user including particulars such as, for example, name 107a, height 107c, weight 107d, hair color or cut 107e, age 107i, eye color 107f, address 107g, identifying marks 107h and it should be understood that this list is merely exemplary and not all compilations will require each of these items of data and may, as said, include only one item of identifying information such as, a driver's license number as depicted by reference 107j. Code 107b is a code that is transmitted by the transmitter part of transceiver 200 when the registered user determines that he or she is in a crisis situation and triggers transmission of a distress signal 105. Code 107b identifies the registered user that initiated the distress signal and that distress signal code 107b will allow authorities to promptly undertake a search for the registered user knowing the current location data and particular information about the person for whom they are looking.

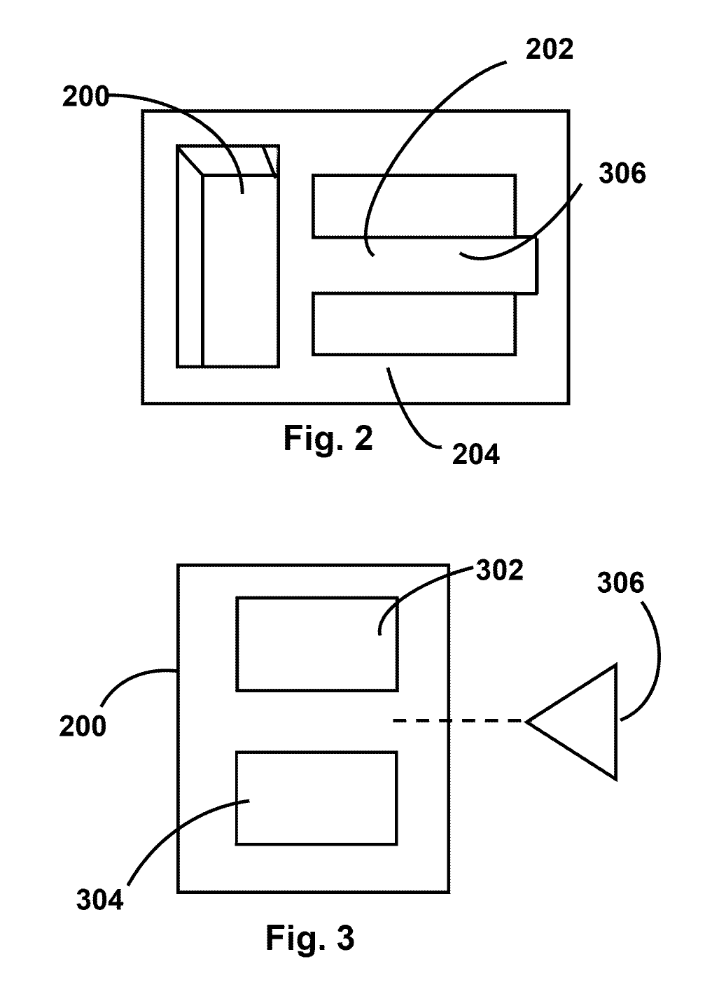

FIG. 2 is an enlarged depiction of the backside of a part of personal item 102, in this case the buckle from FIG. 1 showing transceiver module 200 integrated into the accessory. Transceiver module 200 is shown in further detail in FIG. 3 that illustrates two functional modules of transceiver module 200, a location determination or receiver module 302 and a transmitting module 304. It should be understood that location determination module (receiver) 302 and transmitting module 304 are shown as separate modules for ease of comprehension and there is no need for them to literally be separate modules and they may be integrated and their respective circuits integrated. They are merely shown separately to assist in explaining exemplar functionality of the transceiver module 200 employed in a preferred embodiment.

Location determination module 302 is, in a preferred embodiment, a GPS receiver. Other types of location determination circuitry may be employed for location determination but other techniques besides GPS are typically more expensive and not as comprehensive in global coverage although they may be employed.

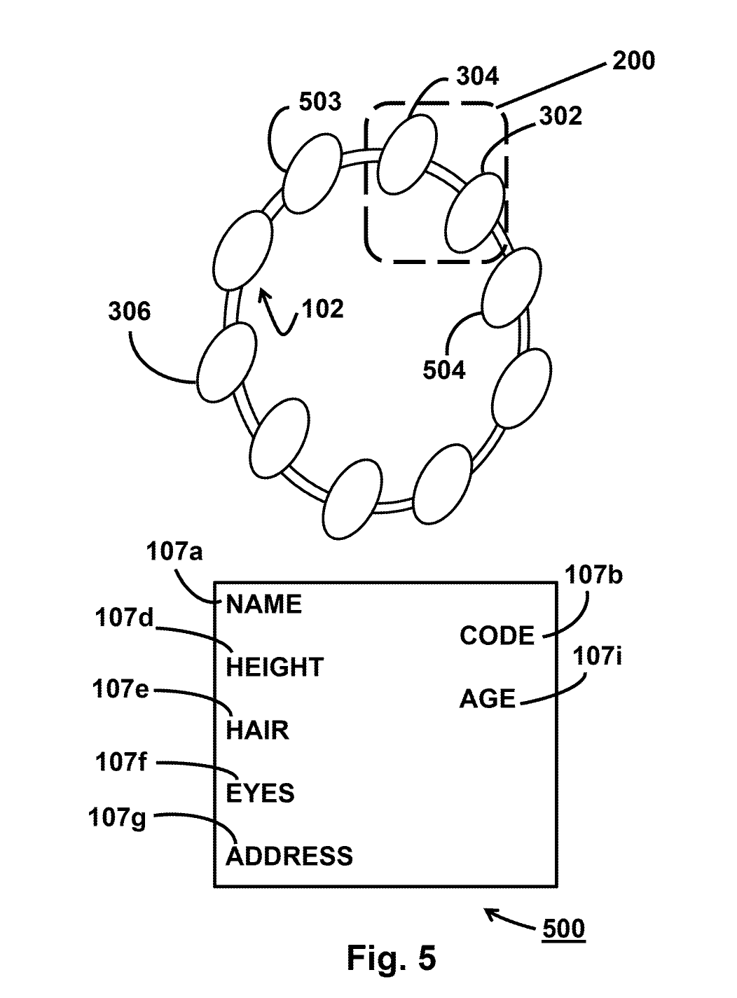

As those of skill understand, a GPS receiver is best utilized with an antenna and a better antenna typically allows a less sophisticated receiver to be employed along with requiring lower power consumption by the receiver. Consequently, in more compact embodiments, a part of the personal item 102 may be employed as an antenna 306 for transceiver module 200. In the case of the depicted belt buckle employed as part of personal item 102, the buckle tang 202 functions as antenna 306. The frame 204 of a buckle type personal item 102 may also be employed as an antenna 306. Similarly, for example, in a bracelet as depicted in later FIG. 5, one bangle of the bracelet may contain a receiver module 302 and another may contain or include transmitter module 304 while another may function as the antenna 306 and still another may contain a battery for use as a power source for the receiver and transmitter modules.

Returning to the belt/buckle example of FIGS. 2 and 3, a typical GPS module such as a Venus638FLPx single chip GPS module may be employed as location determination or receiver module 302. Those of skill will recognize that location determination circuitry is available in a variety of configurations and in embodiments of the present invention many different configurations of such circuitry may be employed whether as modules such as the Venus638 exemplar mentioned, other modules such as larger machines such as those provided by Trimble, or custom circuitry built into the personal accessory and all such varieties may be employed in the present invention subject only to design considerations and power consumption matching with the application and space available. Smaller location determination modules may currently occupy a footprint of 10 mm×10 mm×1.3 mm or smaller.

Typically, GPS modules update multiple times per second but as those of skill will recognize, lower power consumption can be achieved by less frequent location updating. A module that updates only every second, all else being equal, will typically use less power than a similar module that updates many times per second therefore preserving battery energy for a longer period of time which is a consideration of value in the context of the present invention.

The output from location determination module 302 is used by transmitter module 304 to convey location data on a monitored frequency or by text to a 911 or similar system, for example. The location data is preferably longitude and latitude coordinate data that is well recognized around the world.

Transmitter module 304 sends a distress signal that includes code 107b (see e.g., reference 107b with reference to FIG. 1B) and location information. It may also convey a characteristic signal pattern or code identifying itself as a distress signal along with the location information and identifying code that points to or links to the identifying criteria associated with the registered user employing system 100 to indicate a personal safety or well-being crisis experienced by the user.

Because transmitter module 304 should be capable of transmitting simple codes, it need not be complex. For example, a 74HC240 octal buffer can be used to amplify the signal (Morse code) from an ATTiny44a with a 29 MHz oscillator to create a simple transmitter module 304.

If location determination module 302 is implemented with a GPS receiver, the output signal conveyed for interface to transmitter 304 will typically be arranged in one of three protocols: Trimble Standard Interface Protocol (TSIP), Trimble ASCII Interface Protocol (TAIP), or NMEA 0183. Protocol selection and port characteristics are user configurable on some GPS receivers that could be used as a location determination module 302. As those of skill will recognize, the common GPS output protocols include TSIP which is a powerful binary packet protocol that allows a system designer substantial configuration control over the GPS receiver. TSIP supports over 20 commands and their associated response packets. The protocol known as TAIP is the Trimble ASCII interface protocol designed specifically for tracking applications. It is a bi-directional protocol using ASCII commands with the associated ASCII responses and a table 1-1 below taken from a Trimble publication http://www.n4iqt.com/trimble/TrimbleAceII/taip.pdf. NMEA 0183 is an industry standard protocol common to marine applications.

The following table lists all the TAIP messages currently defined and comments regarding their application:

TABLE C-5
Message Data String Descriptions

| Identifi- | | Frequency and | | Response/ | |
|---|---|---|---|---|---|
| er | Message Name | Distance | Query | Report | Set |
| AL | Altitude/Vertical | X | X | X | X |
| | Velocity | | | | |
| AP | Auxiliary Port | | X | X | X |
| | Characteristic | | | | |
| CP | Compact Position | X | X | X | X |
| | Solution | | | | |
| DC | Differential | | | | X |
| | Corrections | | | | |
| DD | Delta Differential | | | | X |
| | Corrections | | | | |
| ID | Vehicle ID | X | X | X | X |
| IP | Initial Position | X | X | X | X |
| LN | Long Navigation | X | X | X | |
| | Message | | | | |
| PR | Protocol | | X | X | X |
| PT | Port Characteristic | X | X | X | X |
| PV | Position/Velocity | X | X | X | X |
| | Solution | | | | |
| RM | Reporting Mode | X | X | X | X |
| RT | Reset | | | | X |
| ST | Status | X | X | X | |
| TM | Time/Date | X | X | X | |
| VR | Version Number | X | X | X | X |

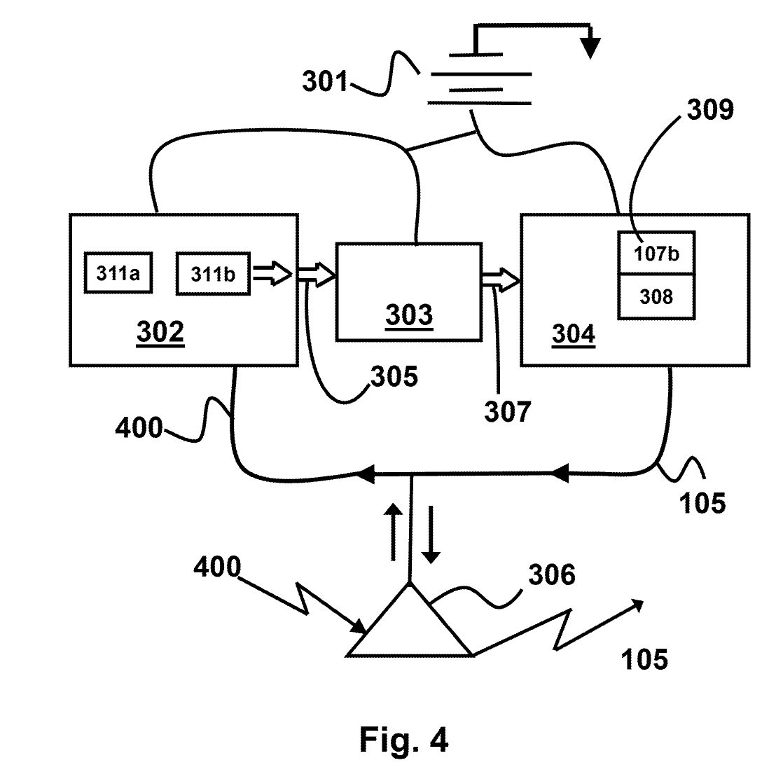

FIG. 4 depicts a block diagram of electronic circuitry employed in a preferred embodiment of the present invention and powered by battery 301. Battery 301 is preferably a long life lithium battery but also may be a rechargeable battery powered by a solar cell built into personal item 102 such as, for example, a pendant on a necklace.

Receiver module 302 is depicted as receiving PRN GPS satellite signal 400 on antenna 306. Process blocks 311a and 311b depict the updating of sequential transmission of location information conveyed in the output protocol configured signal 305 of receiver module 302. Receiver module 302 can be integrated, if needed, with transmitter module 304 with optional inter-signal module 303 that can receive the signal output protocol signal 305 of receiver module 302 and condition that signal into a signal protocol 307 intelligible to the selected transmitter module 304 to allow the on-board program 309 of transmitter module 304 to apprehend the location data 308 of the personal item 102. On-board program 309 has access to or includes code 107b which, along with the location data 308 is transmitted by distress signal 105 from antenna 306 as either a text message to the text capable 911 system or on a monitored frequency although in alternative embodiments it may be configured as a text message to another phone number other than to the 911 system. Distress signal 105 is preferably configured as a text message for conveyance to the text capable 911 system or on a frequency likely to be apprehended by authorities. In short, in such an embodiment, transmitter module 304 is preferably a single number transmitting only to a phone (i.e., to 911) or a simple signaling transmitter. Thus, in a more preferred embodiment, transmitter 304 is configured as a text messaging phone transmitter attuned to convey code 107b and coordinate location information to a text capable 911 system.

If a monitored frequency is employed to convey a distress signal 105 from transmitter 304, the frequency is preferably selected based upon the geographic area of use given that some frequencies are monitored in some locales and other frequencies are monitored in other locales.

The following is a partial list of emergency frequencies employed in various parts of the United States:

39.46: Used for inter-department emergency communications by local and state police forces.

47.42: Used across the United States by the Red Cross for relief operations.
52.525: Calling frequency used by ham radio operators in FM on their six-meter band.
146.52: Used by ham radio operators for non-repeater communications on the two-meter band; it is very busy in many parts of the country.
151.625: Used by “itinerant” businesses, or those that travel about the country. Circuses, exhibitions, trade shows, and sports teams are some of the users you can hear. Other widely used itinerant channels are 154.57 and 154.60.
154.28: Used for inter-department emergency communications by local fire departments; 154.265 and 154.295 also used.
155.160: Used for inter-department emergency communications by local and state agencies during search and rescue operations.
155.475: Used for inter-department emergency communications by local and state police forces.
164.50: National communications channel for the Department of Housing and Urban Development.
168.55: National channel used by civilian agencies of the federal government for communications during emergencies and disasters.
462.675: Used for emergency communications and traveler assistance in the General Mobile Radio Service.

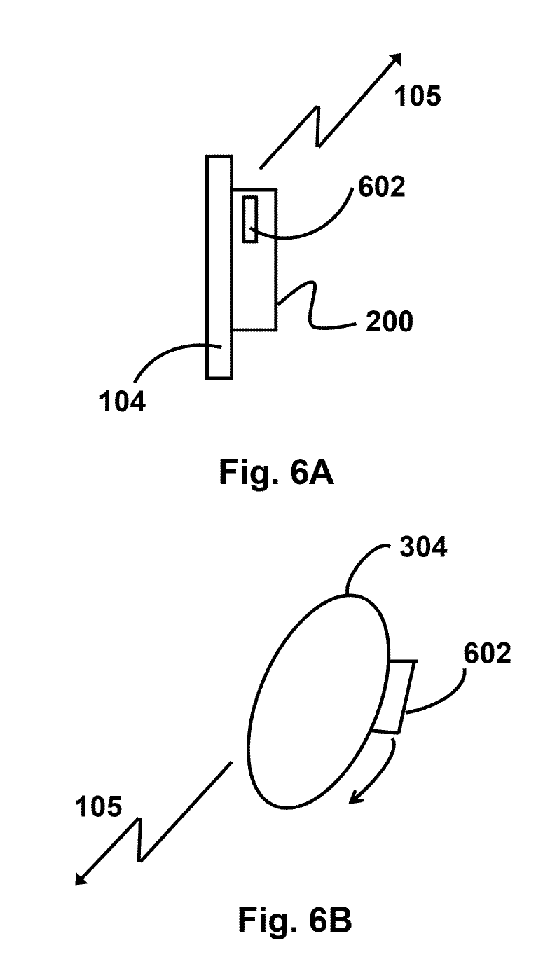

FIG. 5 depicts an alternative embodiment of the present invention as deployed using a bracelet as personal item 102 and data compilation 500 with fewer data entries 107a (name), 107d (height), 107e (hair), 107f (eyes), 107g (address), 107i (age) and code 107b. Code 107b is the code associated with the other enumerated data entries associated with the registered user in possession of the personal item 102 that employs receiver module 302 and transmitter module 304. In this embodiment, a bracelet is an advantageous embodiment for a personal item 102 because it may have room for two batteries such as are identified as 503 and 504 thus allowing longer use time between battery changes and a more powerful transmitter module 304 and a greater margin of safety. A bracelet is further an advantageous embodiment for a personal item 102 because even if a registered user finds that his or her hands tied, fingers may still be able to initiate a distress signal on switch 602 as shown in FIGS. 6A and 6B.

As shown in FIG. 6A, a side view of the buckle embodiment of personal item 102 earlier shown in FIG. 1A depicts a trigger 602 that may be deployed by the registered user to initiate distress signal 105. Trigger 602 is shown as a pressure switch in FIG. 6A and a slide switch in FIG. 6B as examples of switches that may be employed in embodiments of the present invention. In a preferred embodiment of system 100, to cause trigger 602 to enable transmission of a coded distress signal 105, trigger 602 may be initiated in a predefined pattern to reduce incidences of false alarms that could otherwise be caused by accidental enablement. Even a simple initiating pattern of being pressed or slid back and forth twice will reduce the incidences of false alarms and may easily be done in most circumstances although no particular pattern is required.

I claim:

1. A personal security system embedded in a personal item, the system comprising:
a transceiver configured to receive GPS location data from which is derived data representative of the location data, the transceiver including a transmitter configured to transmit a text message to a 911 system, the text message comprising coordinate location information and an identifying code configured to identify visible physical features descriptive of the individual that is a user of the system; and
a trigger that initiates transmission of the text message.

2. The system of claim 1 in which the identifying code identifies two or more of the following visible physical features descriptive of the individual that is a user of the system: height, hair color, eye color, weight and age.

3. The personal security system of claim 2 in which the person item is a belt buckle.

4. The personal security system of claim 2 in which the personal item is a necklace.

5. The personal security system of claim 2 in which the personal item is a bracelet.

6. The personal security system of claim 2 in which the personal item is a shoe.

7. The personal security system of claim 2 in which the personal item is an article of clothing.

8. A personal security system disguised by association with a personal item, the system comprising:
a receiver configured to receive location data from the GPS system and express that location data in a selected protocol;
a transmitter configured to receive the selected protocol expressing the location data and associate the location data with an identifying code configured to identify visible physical features descriptive of the individual user of the system including hair color and height and age information and transmit the identifying code and the location data; and
a trigger that initiates conveyance of a distress signal that comprises the identifying code and the location data.

9. (canceled)

10. The personal security system of claim 8 in which the location data is expressed in latitude and longitude coordinates.

11. The personal security system of claim 8 in which the distress signal is a text message conveyed to a 911 emergency system.

12. The personal security system of claim 8 in which the distress signal is conveyed on a monitored frequency.

13. The personal security system of claim 8 in which the personal item is a bracelet.

14. The personal security system of claim 8 in which the personal item is a belt buckle.

15. A personal security system comprising:
a personal item that in part disguises a receiver configured to receive location data from the GPS system and express that location data in a selected protocol;
a transmitter configured to receive the selected protocol expressing the location data and associate the location data with an identifying code configured to identify visible physical features descriptive of the individual user of the system including hair color and age information and transmit the identifying code and the location data; and
a trigger that initiates conveyance of a distress signal that comprises the identifying code and the location data.

16. The personal security system of claim 15 in which the distress signal is a message intelligible to a 911 system.

17. The personal security system of claim 15 in which the distress signal is conveyed on a monitored frequency.

18. The personal security system of claim 15 in which the personal item is a bracelet.

19. The personal security system of claim 15 in which the personal item is a belt buckle.

20. The personal security system of claim 15 further comprising a solar charging system.
